(19) United States
(12) Patent Application Publication
(10) Pub. No.: US 2026/0160718 A1
(43) Pub. Date: Jun. 11, 2026

(54) MICROFABRICATED DIFFERENTIAL SCANNING CALORIMETRY SYSTEM AND METHODS OF USE THEREOF

(71) Applicant: University of Louisville Research Foundation, Inc., Louisville, KY (US)

(72) Inventors: Thomas J. Roussell, JR., Louisville, KY (US); Nichola C. Garbett, Louisville, KY (US); Alexa M. Melvin, Louisville, KY (US)

(21) Appl. No.: 19/378,120

(22) Filed: Nov. 3, 2025

Related U.S. Application Data
(63) Continuation of application No. 17/771,487, now Pat. No. 12,487,200.
(60) Provisional application No. 62/925,742, filed on Oct. 24, 2019.

(51) Int. Cl. G01N 25/48; G01K 17/00

(52) U.S. Cl. CPC G01N 25/4866; G01K 17/006; G01N 25/4813

(57) ABSTRACT

A differential scanning calorimetry sensor, comprises a substrate; a heater trace comprising a conductive material, on the substrate; an encapsulation layer, on the substrate and on the heater trace; and a sample heating area, which is on the heater trace. The heater trace has a thickness of 50 to 1000 nm, a width of 1 to 100 μm, and a path length of 5 to 500 mm. Also described are a sample holder, a sensor enclosure and a thermal analysis sensor system.

### GOVERNMENT RIGHTS

This invention was made with government support under Grant No. U01 HL127518 awarded by the National Institutes of Health and Grant No. U01 HL152392 awarded by the National Institutes of Health. The government has certain rights in the invention.

### BACKGROUND

Differential scanning calorimetry (DSC) is a thermo analytical technique that measures the thermal profile (thermogram) of biomolecules. DSC is the method of choice for thermodynamic studies of protein denaturation, where temperature-induced unfolding of proteins can be directly measured without need for derivatization or secondary probes. DSC may be used as an alternate, complementary approach to characterize changes in the overall biomolecular makeup of a sample, including changes in concentrations, structures, modifications, interactions or reactions involving biomolecules and disease markers, for disease detection and monitoring. The novel application of DSC for diagnosing and understanding human disease has generated significant data indicating that observable differences in the thermodynamic properties of human plasma can be used to differentiate clinical samples based on health status. Plasma thermogram data for over 15 different cancers, autoimmune and other diseases have been obtained, which show the potential of DSC thermograms to be used in the characterization of different diseases [1-26]. Examples of thermograms obtained for plasma samples from patients with several different diseases is shown by FIG. 1 [1]. See, for example, PCT Pub. Nos. WO 2017/066800, WO 2011/156658, WO 2010/033606 and WO 2008/089072 [27-30]. This approach has been validated by multiple research groups in a variety of disease settings [1-26].

Despite promising results indicating the potential utility of DSC as a clinical tool, development and discovery has been hampered by the need for expensive instrumentation, low experimental throughput, and the specialized training required for data collection and bioinformatics analysis. Thus, the DSC technology at present has been challenging to apply in the clinical setting.

### SUMMARY

In a first aspect, the invention is a differential scanning calorimetry sensor, comprising a substrate; a heater trace comprising a conductive material, on the substrate; and an encapsulation layer, on the substrate and on the heater trace. The heater trace has a thickness of 50 to 1000 nm, a width of 1 to 100 μm, and a path length of 5 to 500 mm.

In a second aspect, the invention is a sample holder for differential scanning calorimetry, comprising a sample holder body having an external surface; a sample chamber having a volume of 1 to 500 μL, inside the sample holder body; and an inlet channel and an outlet channel, each fluidly connecting the sample chamber to the external surface of the sample holder body. The sample holder body has an isolation membrane, separating the sample chamber from the external surface, and the isolation membrane has a thickness of at most 500 μm.

In a third aspect, the invention is a sensor enclosure, comprising an enclosure base; a first printed circuit board on the enclosure base; a differential scanning calorimetry sensor, on and electrically connected to the first printed circuit board; optionally a second differential scanning calorimetry sensor on and electrically connected to the first printed circuit board; and an electrical connector electrically connected to the first printed circuit board, passing through the enclosure base.

In a fourth aspect, the invention is a thermal analysis sensor system, comprising (a) a sensor enclosure, comprising (i) an enclosure base, (ii) a first printed circuit board on the enclosure base, (iii) a differential scanning calorimetry sensor, on and electrically connected to the first printed circuit board, and (iv) an electrical connector electrically connected to the first printed circuit board, passing through the enclosure base; and (b) a sample holder, on the differential scanning calorimetry sensor, comprising (A) a sample holder body having an external surface, (B) a sample chamber having a volume of 1 to 500 μL, inside the sample holder body, and (C) an inlet channel and an outlet channel, each fluidly connecting the sample chamber to the external surface of the sample holder body. The sample holder body has an isolation membrane, separating the sample chamber from the external surface, and the isolation membrane has a thickness of at most 500 μm. The differential scanning calorimetry sensor comprises (1) a substrate, (2) a heater trace comprising a conductive material, on the substrate, and (3) an encapsulation layer, on the substrate and on the heater trace. The heater trace has a thickness of 50 to 1000 nm, a width of 1 to 100 μm, and a path length of 5 to 500 mm.

In a fifth aspect, the invention is a method of preparing a thermogram of a liquid sample with a differential scanning calorimetry sensor, comprising scanning the liquid sample by increasing a current in the heater trace from an initial current to a final current in stepwise increments, where each increment is maintained for a dwell time; measuring the voltage applied during each dwell time; and preparing a thermogram based on the current and voltage of each increment.

### DEFINITIONS

The resistance of the heater trace means the resistance at 25° C.

### BRIEF DESCRIPTION OF THE DRAWINGS

The invention can be better understood with reference to the following drawings and description.

FIG. 1 is a graph showing mean thermograms for blood plasma samples obtained from individuals diagnosed with various cancers and diseases.

FIG. 2 is a schematic of a cross-section of a DSC sensor device.

FIG. 3 shows images of a DSC sensor.

FIG. 4 shows the heater trace, in a different pattern than in FIG. 3.

FIG. 5 is an illustration of a simplified fabrication process for a DSC sensor device.

FIG. 6 illustrates a cross-section of a sample holder.

FIG. 7 illustrates a sample holder, with “wings”.

FIG. 8 illustrates an alternative design of a sample holder, without “wings”.

FIG. 9 illustrates still another alternative design of a sample holder, with “wings” and air pockets.

FIG. 10 illustrates a portion of a DSC sensor enclosure

FIG. 11 Illustrates a cross-section of a thermal analysis sensor system.

FIG. 12 is a flowchart illustrating the steps in a control program.

FIG. 13 is a graph showing an example of raw data and baseline data.

FIG. 14 is a graph showing the resulting data after baseline subtraction.

### DETAILED DESCRIPTION

The present application describes a simplified point-of-care microelectromechanical system (MEMS) based thermal analysis sensor system, which can be used in the clinical setting to enhance diagnosis and monitoring of disease, particularly for hard to diagnose conditions such as lupus and Lyme disease. For example, while serological testing exists for Lyme disease, this testing is limited secondary to a high false negative rate (negative test result in patients that truly have Lyme disease). This can result in worsening of an untreated disease and prolonged, sometimes lifelong suffering. Preliminary data demonstrates that DSC testing may allow for earlier more accurate and more efficient diagnosis of Lyme disease—resulting in earlier treatment that may result in superior outcomes. The system includes a DSC sensor which includes a conductive trace which can act as both a heater and a temperature sensor. A sample holder, with a size and shape designed to be placed on the DSC sensor, and having a sample chamber, may be used to hold a sample during DSC analysis, for preparing a thermogram of the sample. A system enclosure which holds the DSC sensor, having an enclosure base and enclosure lid, may be used to isolate the DSC device and the sample holder while preparing the thermogram of the sample, and optionally includes one or more printed circuit boards for providing electrical connection to the DSC sensor. Optionally, the system may include a second DSC sensor device for the simultaneous measurement of a control sample.

The thermal analysis sensor system of the present application allows for expanded application for the analysis of biofluid samples with low protein concentrations, such as saliva, cerebrospinal fluid, and urine, in addition to plasma. This opens up the possibility for the development of new, DSC-based diagnostic tests based on biofluids other than plasma and serum. Additionally, it would allow for the application of DSC to new research areas for the analysis of biological samples, for example conditional media from cell culture or bacterial culture, where the protein concentration is not always high. Extension of the scanning temperature range of the sensor could also allow use in other industries outside of the clinical or research fields, such as food science, and the analysis of oils, liquid polymers, etc.

FIG. 2 is a schematic of a DSC sensor device, 10, shown in cross-section. The DSC sensor includes an optional base, 20, a substrate, 16, on the base, a heater trace, 22, on the substrate, a first encapsulation layer, 12, on the substrate and the heater trace, an optional heat spreader, 14, on the heater trace, and an optional second encapsulation layer, 13, on the heat spreader. A sample heating area, 28, is also shown.

The substrate comprises an electrically insulating material, such as an oxide including silicon oxide. The base supports the substrate and may be formed of any material. Preferably, the base is silicon, and the substrate is a silicon oxide layer.

The heater trace may be formed of any conductive material, but preferably includes a highly conductive metal such as gold, silver, platinum or aluminum. Typically, an adhesion layer, such a chromium or titanium, is applied on the substrate, followed by application of the more conductive metal, to improve adhesion of the conductive metal to the substrate. The heater trace preferably has a thickness of 50 to 1000 nm, more preferably 300 to 600 nm, and preferably has a width 1 to 100 μm, more preferably 10 to 30 μm.

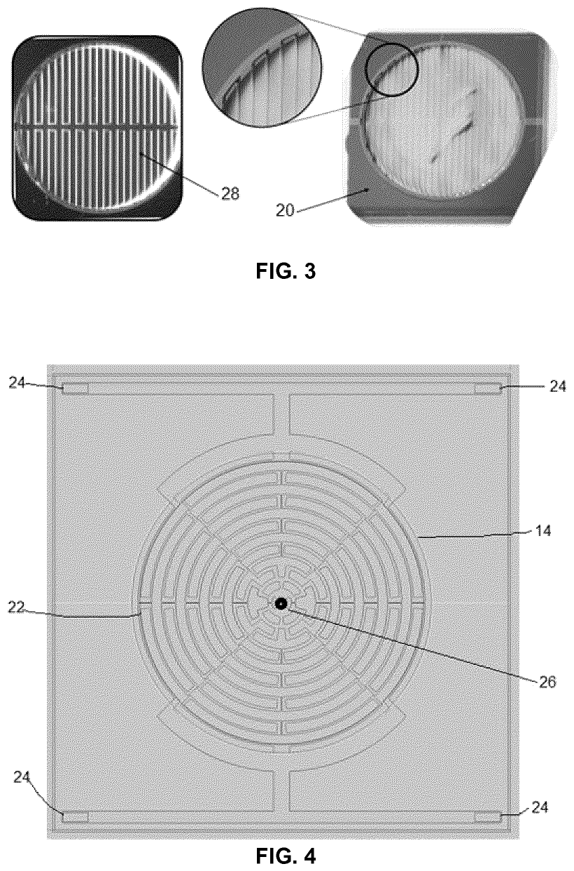

FIG. 3 shows images of a DSC sensor, with a first side on the left, and the opposite side on the right (showing the base, 20). A heater trace is visible in the image, forming a rectilinear path across the sample heating area, 28. The heater trace forms a path which travels along the surface of the substrate on which a sample will be heated (the sample heating area), to carry out DSC and obtain a thermogram. Typically, the sample heating area has the shape of a circle or square with an area of 3 to 625 mm², including 20, 30, 40, 50, 60, 70, 80, 90 and 100 mm². The diameter of the sample heating area (or length of a side of the sample heating area when in the shape of a square) may be 2 to 25 mm, including 3, 4, 5, 6, 6.5, 7, 7.2, 8, 9, 10, and 15 mm.

FIG. 4 shows the heater trace, 22, in a different pattern than in FIG. 3. The ends of the heater trace will extend beyond the sample heating area to form electrical connections, 24, such as metal pads. Also shown in the figure is the outline of the heat spreader, 14, and an optional heat sensor, 26. Preferably, no separate heat sensor is included. The path length, thickness and width of the heater trace can each be adjusted to control the resistance. The path length may be, for example 5 to 500 mm, preferably 10 to 100 mm, including 45 mm. The resistance of the heater trace (measured at 25° C.) is preferably 10 to 1000 ohms, more preferably 50 to 500 ohms, including 80, 100, 150, 200 and 250 ohms.

The heater trace may be used as a temperature sensor. The DSC sensor may be thermally cycled in a temperature-controlled oven to remove any stress from fabrication, and at the same time the resistance of the heater trace may be recorded. The resistance of a metal heater trace will typically be linear, allowing tight control of temperature ramping. Ramping current or voltage (and thus indirectly ramping temperature) creates a controlled method of ramping the temperature of the sensor over a specified temperature range (such as 25 to 150° C.). The elimination of a separate temperature sensor keeps the DSC sensor more compact and simpler to manufacture. Optionally, a temperature sensor may be included in the DSC sensor, and may be made of a thin piece of metal (such as platinum) so that the temperature may be measured by monitoring resistance of the thin piece of metal (an RTD); alternatively, a thermocouple or thermopile could be used. Alternatively, the temperature of the sample may be measured after calibration using temperature standards, such as lipids. Calibration could also be carried out using optical methods to measure the temperature of the sensor.

The heat spreader helps ensure even distribution of the heat generated by the heater trace across a sample heating area. The heat spreader may be formed of any highly heat conductive material, preferably a metal such as gold or aluminum. Preferably, the heat spreader has a thickness of 30 to 1000 nm, more preferably 40 to 50 nm. The encapsulation layer (or layers) may be formed of any electrically insulating material, and is preferably a polymer, such as polyimide. Preferably, the polymer may be spin coated onto the heat trace and the substrate, and then an optional second layer spin coated on the heat spreader. The encapsulation layer (or layers) should be thick enough to protect the heat trace and the heat spreader from the environment, but thin enough to allow quick conduction of the heat from the heat trace. Preferably, the encapsulation layer or layers each have a thickness of 1 to 15 μm, more preferably 2 to 10 μm.

A DSC sensor was prepared as shown in FIG. 3; the width of the heater trace is 10 μm, formed of 520 nm thick platinum on 30 nm titanium (as an adhesion layer), encapsulated in 3 μm thick polyimide, covering a 7.2 mm diameter circular sample heating area, resulting in a heater trace having a resistance of 240 ohms. Using a Keithley 2450 SOURCEMETER™ to perform experiments using lysozyme as a plasma protein surrogate demonstrate that this configuration has adequate sensitivity to produce a thermogram signal for concentrations of lysozyme similar to those typically measured using commercial DSC instrumentation. Lipid standards may be used to calibrate the sensor for temperature by determining the current required to reach known lipid transition temperatures within the desired temperature range.

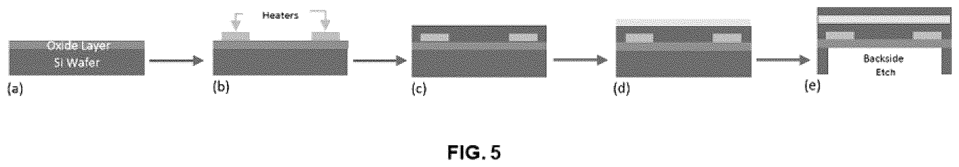

A simplified overview of one possible fabrication process is shown in FIG. 5. In (a), a silicon wafer may be used as the base, with a native oxide layer on the top surface serving as the substrate. In (b), a heater trace may be patterned via sputtering (for example, gold on chromium (as the adhesion layer) electrical path, 300-400 nm thick, 10-20 μm wide, 45 mm long; approximate resistance of 250 ohms at 25° C.), on the top of the oxide layer. In (c), an encapsulation layer (for example, a polyimide layer) may be added via spin coating to passivate and enclose the heater trace. In (d), sputtering of a layer of metal (such as aluminum) to form a heat spreader. In (e), an optional second encapsulation layer may be formed to protect the heat spreader, followed by a backside reactive ion etching process using, for example XeF₂, may be used to isolate the substrate.

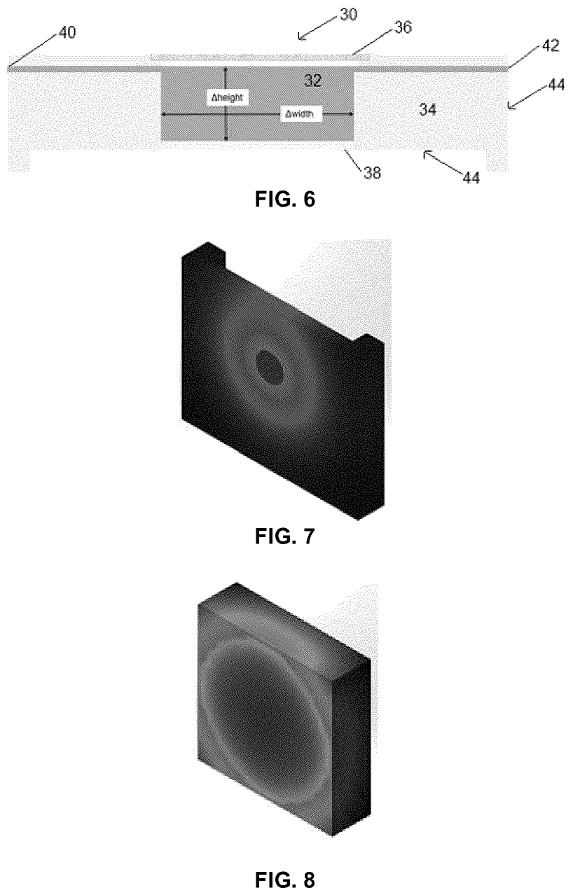

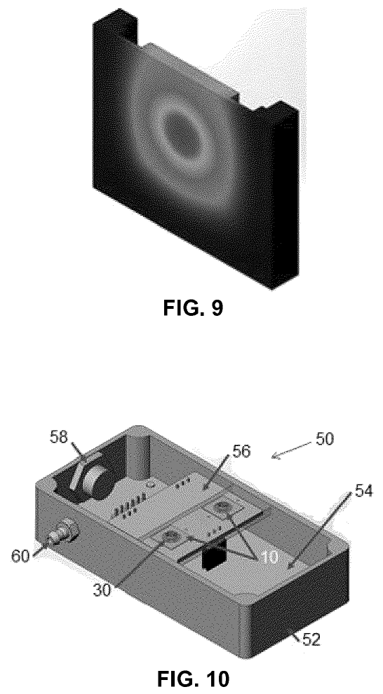

FIG. 6 illustrates a cross-section of a sample holder, 30. The sample holder includes a sample chamber, 32, and an inlet channel, 40, and an outlet channel, 42, each channel fluidly connecting the sample chamber with the external surface, 44, of the sample holder body. The sample chamber is defined by an isolation membrane, 38 (which separates the sample chamber from the external surface), the sample holder body, 34, which surrounds the sample chamber, and a sample chamber cap, 36. A plasma sample, diluted and ready for analysis, may be placed into the sample chamber using a syringe or pipette, through the inlet channel; alternatively, the sample holder may be formed with a tube attached to the inlet channel for filling the sample chamber. Preferably, the sample chamber has a volume of 1 to 500 μL, more preferably 2 to 50 μL, including 3, 4, 5, 6, 7, 8, 9, 10, 15, 20, 25, 30, 35, 40 and 45 μL. Preferably, the isolation membrane has a thickness of at most 500 μm, such as 100 to 500 μm, more preferably at most 300 μm, such as 150 to 300 μm, including 200 and 250 μm. Preferably, the height of the sample chamber is 0.25 to 4 mm, more preferably 0.5 to 2 mm. Preferably, the sample holder has a diameter not larger than the DSC sensor, and the shape and the width (diameter) of the sample chamber is sized to fit on to the sample heating area of the DSC sensor, for example 2 to 25 mm, including 3, 4, 5, 6, 6.5, 7, 7.2, 8, 9, 10, and 15 mm. The sample holder body and isolation membrane may be formed of any non-reactive biocompatible material, such as a polymer, including polydimethylsiloxane (PDMS). Similarly, the sample chamber cap may be formed of any solid material non-reactive with plasma, such as a polymer, including polydimethylsiloxane (PDMS), polymethyl methacrylate (PMMA), or glass. FIG. 7 illustrates a sample holder with a design similar to that shown in FIG. 6. FIG. 8 illustrates an alternative design of sample holder, without “wings”; the “wings” help the sample holder to conform to the surface of the DSC sensor. FIG. 9 illustrates still another alternative design of sample holder, with “wings” and air pockets to help isolate the sample chamber. In FIGS. 7, 8 and 9, each shade of gray shows isothermal regions from simulations of heating the sample holders on a DSC sensor. Soft lithography techniques or injection molding may be used to form the body of the sample holder, and a thin slab of cured PDMS or a glass coverslip may be attached to form the sample chamber cap (for example, via oxygen plasma treatment) to create the completed sample holder.

FIG. 10 illustrates a portion of an optional sensor enclosure, 50, with the enclosure lid removed to show interior detail. Use of a sensor enclosure will aid to isolate the sensor from the external environment and provide convenient electrical connections to the DSC sensor. The sensor enclosure is shown with two DSC sensors, 10, but it may also be designed to hold only a single DSC sensor. On the DSC sensors are sample holders, 30, with one holding a sample, and the other holding, for example, a control (reference) sample. Such use of a second DSC sensor for a control sample would only be useful if the DSC sensors are selected or designed to be matched with the same resistance, size and design. Also illustrated is a first printed circuit board (PCB), 56, for providing electrical connections to the DSC sensors and holding the DSC sensors in place, and an optional second PCB, 54, for connecting the DSC sensors to external circuits such control hardware, via electrical connector, 58. Also illustrated is an enclosure base, 52, and an optional vacuum or pressurization port, 60, for evacuating or pressurizing the sensor enclosure.

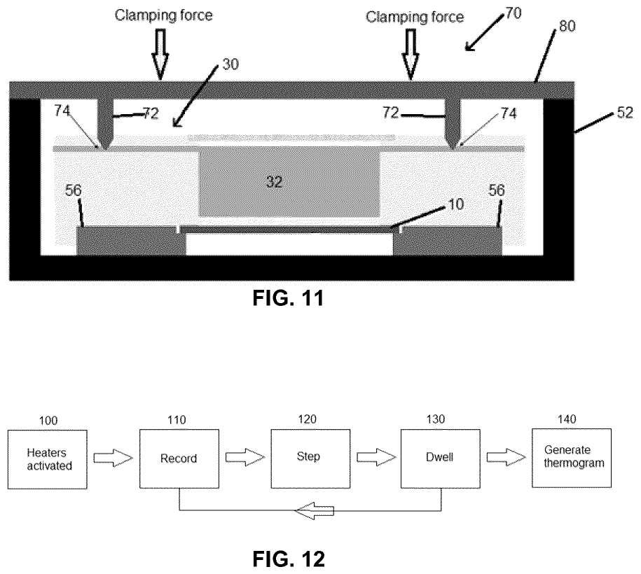

FIG. 11 Illustrates a cross-section of thermal analysis sensor system, 70, sectioned through a sensor to show the placement of the DSC sensor, 10, on the first PCB, 56, the sample holder, 30 (including the sample chamber, 32), the sensor enclosure base, 52, and enclosure lid, 80. Also shown are enclosure lid clamps, 72, which pinch the sample holder inlet and outlet channels, at pinch points, 74, to prevent the sample from leaking out of the sample holder chamber if the interior of the sample enclosure is evacuated. Preferably, the sample holder is placed into contact with the substrate side of the DSC sensor, rather than the side closer to the heat spreader, because the heat spreader may become slightly concave during heating due to a mismatch in the coefficients of thermal expansion (CTE), breaking intimate contact between the DSC sensor and the sample holder; this flexing ensures intimate contact when the sample holder is placed into contact with the substrate side. Alternatively, the sample holder may be designed with a concave isolation membrane to allow for placement on the heat spreader side of the DSC sensor; or a thin glass layer could be added to balance out the CTE.

FIG. 12 is a flowchart illustrating the steps in a control program for obtaining a thermogram of a sample. Initially, a heating rate and scanning temperature range will be determined. Then, the DSC sensors (“heaters”) are activated at 100 by passing current through the heater trace. Next, the current and voltage are recorded, or resistance of the heater trace is calculated to determine the temperature which is then recorded (or optionally, using a thermal sensor or resistance-temperature calibration curve generated using lipid temperature standards), at 110; if matched DSC sensors are used for a sample and a control, then the power applied to the heaters will be adjusted to ensure constant and consistent temperature between the two chambers. The temperature will then be increased, at 120, by increasing the current or voltage. Then, the increase will be maintained for a dwell time, at 130. Steps 110, 120, and 130, will be repeated until the temperature range has been scanned. Typically, data is recorded continuously during the scan. The power applied to the chamber for the given temperature along with the scanning rate is used to determine the differential heat capacity, either during the recording step 110, or from the recorded data at the end of the scanning. The differential heat capacity is then plotted against the temperature to obtain a thermogram, at 140.

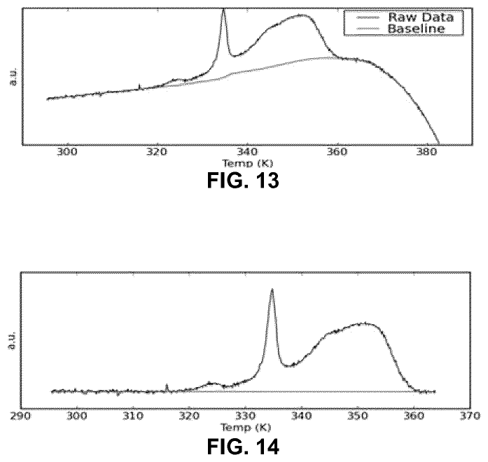

Several different protocols for preparing thermograms of samples are possible. A “blank” data sample may be obtained using a temperature scan of buffer solution with no sample. Next, a scan is performed, using the same parameters for the buffer solution with a certain concentration of sample material added (for example, 1 mg/mL). When the DSC sensor uses the heater trace to also measure temperature, the data may be obtained as current versus power, which may be converted to temperature versus power using the resistance of the heater trace at different temperatures within the scanning temperature range, or based on a temperature calibration curve obtained using standards (such as lipid standards). These two data sets are subtracted, resulting in a differential signal of current versus power, which may be converted to temperature versus power using the known resistance of the heater trace at different temperatures within the scanning temperature range. Alternatively, the conversion to temperature versus power may be carried out first, then the two data sets subtracted; or the power signal may be converted to excess specific heat capacity. In a further variation, ramping voltage, in steps with a dwell time for each step, can be used instead of ramping current. Alternatively, a “blank” buffer and sample could be run in parallel using a pair of matched DSC sensors, either housed together in a single sensor enclosure, or 2 separate DSC sensors. After subtraction of the “blank” data sample, normalization for total protein concentration is performed followed by correction for the sample baseline. Heat capacity is an extensive property, that is, it is proportional to the mass of the substance, thus, normalizing for total protein content allows the direct comparison of plasma samples with different total protein concentrations. Normalization using total protein is one possible method for data normalization. Other possible methods include normalization using the height of a selected peak in the thermogram [10, 18]. During the thermal transition the sample comprises a mixture of folded and unfolded forms of all components, each with different heat capacities. The sample baseline must be selected to estimate the heat capacity of the sample at any temperature during the thermal transition. Various sample baseline correction methods can be used [38], such as, linear baseline, cubic baseline, progress (sigmoidal) baseline, step baseline, spline interpolation, to estimate the sample baseline between the pre-and post-transition regions of the thermogram. FIG. 13 illustrates one example of the sample baseline applied to raw DSC data after subtraction of the “blank” data sample. Subtraction of the sample baseline from these raw data produces the desired final thermogram data for the sample (shown in FIG. 14). Once a thermogram of a plasma sample from a patient is obtain, a visual output may be produced based on the thermogram, and optionally based on reference thermograms, such as printed a graph of the thermogram on paper or displayed on a monitor, or a comparison of the thermogram with reference thermograms, or even the results of a comparison of the patient thermogram with reference thermograms indicating which different cancer or disease most closely with the patient thermogram.

Factors that can be altered to change the scans include the scanning rate, step size (either based on current, temperature or voltage), dwell time per step, and sample concentration. Physical dimensions of the sample holder, such as isolation membrane thickness and the dimension of the sample chamber, can also change the scans. Exemplary scan rates include 0.1° C./minute to 50° C./minute, including 0.5° C./minute to 10° C./minute. Exemplary step sizes include 0.1 pA to 10 mA, including 1 pA to 1 mA. Exemplary dwell times per step includes 0.1 seconds to 60 seconds, including 0.5 seconds to 10 seconds. Typically, plasma is diluted 25-fold (˜2 mg/mL protein concentration) for analysis, but higher concentrations of protein, for example 10-fold dilution or 5-fold dilution, may be used to enhance the signal. Lower concentrations could also be used. For a scanning temperature range of about 25° C. to 100° C., example scans include: (1) scanning 0.1 to 48 mA over 48 minutes using a step size of 0.1 mA with 6 second dwell time; (2) scanning 0.1 to 40 mA over 40 minutes using a step size of 0.1 mA with 6 second dwell time; (3) scanning 0.05 to 40 mA over 40 minutes using a step size of 0.05 mA with 3 second dwell time; and (4) scanning 0.1 to 40 mA over 20 minutes using a step size of 0.1 mA with 3 second dwell time.

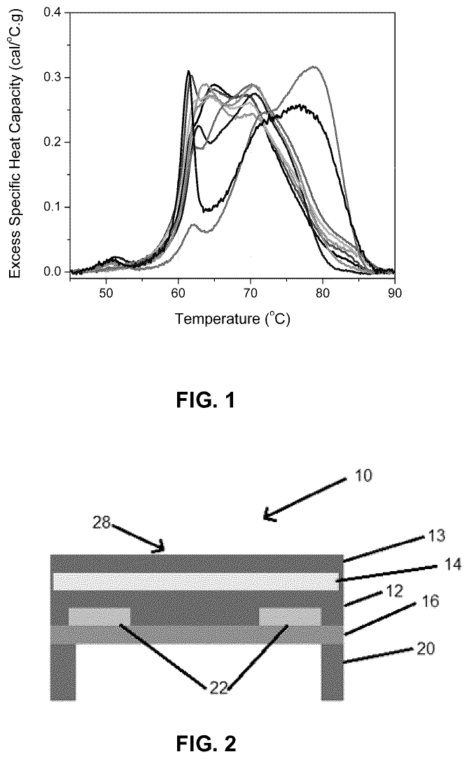

Details of patients from whom samples may be obtained, processing of whole blood samples to obtain plasma for testing, the dilution and other preparation of plasma for testing, and the interpretation of thermograms, may be found in patent application publications, including PCT publication nos. WO 2008/089072, WO 2010/033606, WO 2011/156658, and WO 2017/066800 [27-30, 39]. Preliminary data supports the use of thermograms to characterize diseases including differences in thermograms for various disease states. FIG. 1 displays example data showing differences in mean thermograms for blood plasma samples obtained from individuals diagnosed with various cancers and diseases. Different shades of gray represent a different cancer or disease: endometrial cancer (mean thermogram from 8 patients [N=8]); amyotrophic lateral sclerosis (N=12); lung cancer (N=30); ovarian cancer (N=12); Lyme disease (N=4); systemic lupus erythematosus (N=2); rheumatoid arthritis (N=5); and melanoma (N=5) [18].

### REFERENCES

1. Garbett N C, Mekmaysy C S, Helm C W, Jenson A B and Chaires J B. Differential scanning calorimetry of blood plasma for clinical diagnosis and monitoring. Experimental and molecular pathology. 2009;86:186-91.
2. Garbett N C, Miller J J, Jenson A B and Chaires J B. Calorimetry outside the box: a new window into the plasma proteome. Biophysical journal. 2008;94:1377-83.
3. Garbett N C, Miller J J, Jenson A B and Chaires J B. Calorimetric analysis of the plasma proteome. Seminars in nephrology. 2007;27:621-6.
4. Garbett N C, Miller J J, Jenson A B, Miller D M and Chaires J B. Interrogation of the plasma proteome with differential scanning calorimetry. Clinical chemistry. 2007;53:2012-4.
5. Garbett N C, Miller JJ, Jenson A B and Chaires J B. Ligand Binding Alters the Calorimetric Thermogram of Albumin. J Clin Ligand Assay. 2006;29:194-197.
6. Garbett N C, Merchant M L, Chaires J B and Klein J B. Calorimetric analysis of the plasma proteome: identification of type 1 diabetes patients with early renal function decline. Biochimica et biophysica acta. 2013;1830:4675-80.
7. Garbett N C, Merchant M L, Helm C W, Jenson A B, Klein J B and Chaires J B. Detection of cervical cancer biomarker patterns in blood plasma and urine by differential scanning calorimetry and mass spectrometry. PloS one. 2014;9:e84710.
8. Garbett N C, Brock G N, Chaires J B, Mekmaysy C S, DeLeeuw L, Sivils K L, Harley J B, Rovin B H, Kulasekera K B and Jarjour W N. Characterization and classification of lupus patients based on plasma thermograms. PloS one. 2017;12:e0186398.
9. Kendrick S K, Zheng Q, Garbett N C and Brock G N. Application and interpretation of functional data analysis techniques to differential scanning calorimetry data from lupus patients. PloS one. 2017;12:e0186232.
10. Velazquez-Campoy A, Vega S, Sanchez-Gracia O, Lanas A, Rodrigo A, Kaliappan A, Hall M B, Nguyen T Q, Brock G N, Chesney J A, Garbett N C and Abian O. Thermal liquid biopsy for monitoring melanoma patients under surveillance during treatment: A pilot study. Biochimica et biophysica acta General subjects. 2018;1862:1701-1710.
11. Fekecs T, Zapf I, Ferencz A and Lőrinczy D. Differential scanning calorimetry (DSC) analysis of human plasma in melanoma patients with or without regional lymph node metastases. J Therm Anal Calorim. 2012;108:149-152.
12. Michnik A, Drzazga Z, Michalik K, Barczyk A, Santura I, Sozańska E and Pierzchała W. Differential scanning calorimetry study of blood serum in chronic obstructive pulmonary disease. J Therm Anal Calorim. 2010;102:57-60.
13. Todinova S, Krumova S, Gartcheva L, Robeerst C and Taneva S G. Microcalorimetry of blood serum proteome: a modified interaction network in the multiple myeloma case. Analytical chemistry. 2011;83:7992-8.
14. Todinova S, Krumova S, Kurtev P, Dimitrov V, Djongov L, Dudunkov Z and Taneva SG. Calorimetry-based profiling of blood plasma from colorectal cancer patients. Biochimica et biophysica acta. 2012;1820:1879-85.
15. Zapf I, Fekecs T, Ferencz A, Tizedes G, Pavlovics G, Kálmán E and Lőrinczy D. DSC analysis of human plasma in breast cancer patients. Thermochim Acta. 2011;524:88-91.
16. Chagovetz A A, Jensen R L, Recht L, Glantz M and Chagovetz A M. Preliminary use of differential scanning calorimetry of cerebrospinal fluid for the diagnosis of glioblastoma multiforme. Journal of neuro-oncology. 2011;105:499-506.
17. Chagovetz A A, Quinn C, Damarse N, Hansen L D, Chagovetz A M and Jensen RL. Differential scanning calorimetry of gliomas: a new tool in brain cancer diagnostics? Neurosurgery. 2013;73:289-95; discussion 295.
18. Vega S, Garcia-Gonzalez M A, Lanas A, Velazquez-Campoy A and Abian O. Deconvolution analysis for classifying gastric adenocarcinoma patients based on differential scanning calorimetry serum thermograms. Scientific reports. 2015;5:7988.
19. Krumova S, Todinova S, Mavrov D, Marinov P, Atanassova V, Atanassov K and Taneva S G. Intercriteria analysis of calorimetric data of blood serum proteome. Biochimica et biophysica acta General subjects. 2017;1861:409-417.
20. Todinova S, Krumova S, Danailova A, Petkova V, Guenova M, Mihaylov G, Gartcheva L and Taneva S G. Calorimetric markers for monitoring of multiple myeloma and Waldenstrom's macroglobulinemia patients. European biophysics journal: EBJ. 2018;47:549-559.
21. Todinova S, Krumova S, Radoeva R, Gartcheva L and Taneva S G. Calorimetric markers of Bence Jones and nonsecretory multiple myeloma serum proteome. Analytical chemistry. 2014;86:12355-61.
22. Fish, D. J. et al., “Statistical analysis of plasma thermograms measured by differential scanning calorimetry”, Biophysical Chemistry, vol. 152, no. 1-3, pp. 184-190 (2010).
23. Rai, S. N. et al., “Group classification based on high-dimensional data: application to differential scanning calorimetry plasma thermogram analysis of cervical cancer and control samples”, Open Access Medical Statistics, vol. 3, pp. 1-9 (2013).
24. Garbett, N. C. et al., “Differential scanning calorimetry as a complementary diagnostic tool for the evaluation of biological samples”, Biochimica et Biophysica Acta, vol. 1860, no. 5, pp. 981-989 (2016).
25. Garbett, N. C. et al., “Clinical application of plasma thermograms. Utility, practical approaches and considerations”, Methods, vol. 76, pp. 41-50 (2014).
26. Wisniewski, M. et al., “Differential scanning calorimetry in molecular diagnostics”, In Vitro Diagnostic Technology, vol. 17, no. 6, pp. 29-34 (2011).
27. WO 2008/089072.
28. WO 2010/033606.
29. WO 2011/156658.
30. WO 2017/066800.
31. Wang, L. et al., “Demonstration of MEMS-based differential scanning calorimetry for determining thermodynamic properties of biomolecules”, Sensors and Actuators B: Chemical, vol. 134, pp. 953-958 (2008).
32. Yu, S. et al., “Review of MEMS differential scanning calorimetry for biomolecular study”, Frontiers of Mechanical Engineering, vol. 12, no. 4, pp. 526-538 (2017).
33. Jia, Y. et al., “A polymer-based MEMS differential scanning calorimeter”, Sensors and Actuators A: Physical, vol. 231, pp. 1-7 (2015).
34. Wang, B. et al., “MEMS-based AC differential scanning calorimetry”, 2011 16th International Solid-State Sensors, Actuators and Microsystems Conference, pp. 1958-1961 (2011).
35. Wang, B. et al., “A MEMS differential scanning calorimeter for thermodynamic characterization of biomolecules”, 2011 IEEE 24th International Conference on Micro Electro Mechanical Systems, pp. 821-824 (2011).
36. Wang, B. et al., “A MEMS differential-scanning-calorimetric sensor for thermodynamic characterization of biomolecules”, Journal of Microelectromechanical Systems, vol. 21, no. 5, pp. 1165-1171 (2012).
37. Wang, L. et al., “A MEMS thermal biosensor for metabolic monitoring applications”, Journal of Microelectromechanical Systems, vol. 17, no. 2, pp. 318-327 (2008).
38. Cooper A, Nutley M and Wadood A. Differential scanning microcalorimetry. In: B. Chowdhry and S. Harding, eds. Protein-Ligand Interactions: hydrodynamics and calorimetry: a practical approach Oxford, UK: Oxford University Press; 2001:287-318.
39. WO 2012/109383.

1. A differential scanning calorimetry sensor, comprising:
a substrate,
a heater trace comprising a conductive material, on the substrate, and
an encapsulation layer, on the substrate and on the heater trace,
wherein the heater trace has a thickness of 50 to 1000 nm, a width of 1 to 100 um, and a path length of 5 to 500 mm.

2. The differential scanning calorimetry sensor of claim 1, further comprising a heat spreader on the heater trace,
wherein the substrate comprises an oxide,
the heater trace comprises the conductive material on an adhesion layer,
the conductive material is a metal,
the encapsulation layer comprises a polymer, and
the heater trace has a thickness of 300 to 600 nm, a width of 10 to 30 μm, and a path length of 10 to 100 mm.

3. The differential scanning calorimetry sensor of claim 2, wherein the conductive material comprises gold, silver, platinum, or aluminum.

4. The differential scanning calorimetry sensor of claim 2, wherein the resistance of the heater trace is 10 to 1000 ohms.

5. (canceled)

6. The differential scanning calorimetry sensor of claim 2, wherein the encapsulation layer has a thickness of 1 to 15 μm.

7. The differential scanning calorimetry sensor of claim 2, further comprising:
a base comprising silicon, and
wherein the substrate comprises silicon oxide.

8-10. (canceled)

11. A sample holder for differential scanning calorimetry, comprising:
a sample holder body having an external surface,
a sample chamber having a volume of 1 to 500 μL, inside the sample holder body, and
an inlet channel and an outlet channel, each fluidly connecting the sample chamber to the external surface of the sample holder body,
wherein the sample holder body has an isolation membrane, separating the sample chamber from the external surface, and the isolation membrane has a thickness of at most 500 μm.

12. The sample holder of claim 11, wherein:
the sample chamber has a volume of 2 to 50 μL, and
the isolation membrane has a thickness of at most 300 μm.

13. The sample holder of claim 12, wherein the sample holder body comprises polydimethylsiloxane.

14. A sensor enclosure, comprising:
an enclosure base,
a first printed circuit board on the enclosure base,
the differential scanning calorimetry sensor of claim 1, on and electrically connected to the first printed circuit board, and
an electrical connector electrically connected to the first printed circuit board, passing through the enclosure base.

15. The sensor enclosure of claim 14, further comprising a second printed circuit board, electrically connecting the first printed circuit board to the electrical connector.

16. The sensor enclosure of claim 14, further comprising a port for evacuating or pressurizing the sensor enclosure.

17. The sensor enclosure of claim 14, further comprising an enclosure lid.

18. (canceled)

19. The sensor enclosure of claim 14, further comprising a second differential scanning calorimetry sensor.

20. The sensor enclosure of claim 15, further comprising:
a port for evacuating or pressurizing the sensor enclosure,
an enclosure lid, wherein the enclosure lid comprises enclosure lid clamps.

21. A thermal analysis sensor system, comprising:
(a) a sensor enclosure, comprising:
(i) an enclosure base,
(ii) a first printed circuit board on the enclosure base,
(iii) a differential scanning calorimetry sensor, on and electrically connected to the first printed circuit board, and
(iv) an electrical connector electrically connected to the first printed circuit board, passing through the enclosure base, and
(b) a sample holder, on the differential scanning calorimetery sensor, comprising:
(A) a sample holder body having an external surface,
(B) a sample chamber having a volume of 1 to 500 μL, inside the sample holder body, and
(C) an inlet channel and an outlet channel, each fluidly connecting the sample chamber to the external surface of the sample holder body,
wherein the sample holder body has an isolation membrane, separating the sample chamber from the external surface, and the isolation membrane has a thickness of at most 500 μm,
the differential scanning calorimetry sensor comprises:
(1) a substrate,
(2) a heater trace comprising a conductive material, on the substrate, and
(3) an encapsulation layer, on the substrate and on the heater trace,
wherein the heater trace has a thickness of 50 to 1000 nm, a width of 1 to 100 μm, and a path length of 5 to 500 mm.

22. The thermal analysis sensor system of claim 21, wherein:
the sensor enclosure further comprises:
(iv) a second printed circuit board, electrically connecting the first printed circuit board to the electrical connector,
(v) a port for evacuating or pressurizing the sensor enclosure,
(vi) an enclosure lid, wherein the enclosure lid comprises enclosure lid clamps, and
wherein the differential scanning calorimetry sensor further comprises (4) a heat spreader on the heater trace,
the sample chamber has a volume of 2 to 50 μL,
the isolation membrane has a thickness of at most 300 μm,
the sample holder body comprises polydimethylsiloxane,
the substrate comprises an oxide,
the heater trace comprises the conductive material on an adhesion layer,
the conductive material is a metal,
the encapsulation layer comprises a polymer, and
the heater trace has a thickness of 300 to 600 nm, a width of 10 to 30 μm, and a path length of 10 to 100 mm.

23. A method of preparing a thermogram of a liquid sample with the differential scanning calorimetry sensor of claim 1, comprising:
scanning the liquid sample by increasing a current in the heater trace from an initial current to a final current in stepwise increments, wherein each increment is maintained for a dwell time;
measuring the voltage applied during each dwell time; and
preparing a thermogram based on the current and voltage of each increment.

24. The method of claim 23, wherein the liquid sample is in a sample chamber of a sample holder, the sample holder comprising:
a sample holder body having an external surface,
the sample chamber having a volume of 1 to 500 μL, inside the sample holder body, and
an inlet channel and an outlet channel, each fluidly connecting the sample chamber to the external surface of the sample holder body,
wherein the sample holder body has an isolation membrane, separating the sample chamber from the external surface, and the isolation membrane has a thickness of at most 500 μm.

25. The method of claim 23, wherein:
the liquid sample comprises plasma, and during the scanning, the temperature of the liquid sample ranges from 25° C. to 100° C.

26-27. (canceled)
